(19) United States
(12) Patent Application Publication
(10) Pub. No.: US 2015/0067171 A1
(43) Pub. Date: Mar. 5, 2015

(54) CLOUD SERVICE BROKERING SYSTEMS AND METHODS

(71) Applicant: Verizon Patent and Licensing Inc., Arlington, VA (US)

(72) Inventors: Takkin G. Yum, Briarcliff Manor, NY (US); Matthew J. Threefoot, Columbia, MD (US); Cheul Shim, Harrington Park, NJ (US)

(73) Assignee: Verizon Patent and Licensing Inc., Arlington, VA (US)

(21) Appl. No.: 14/015,750

(22) Filed: Aug. 30, 2013

(51) Int. Cl. H04L 29/08

(52) U.S. Cl. CPC H04L 67/10
USPC 709/226

(57) ABSTRACT

An exemplary method includes a computer-implemented cloud service brokering system that provides a cloud service brokering service 1) registering a plurality of cloud services with the cloud service brokering service, the plurality of cloud services provided by a plurality of cloud service providers and configured to provide distinct sets of cloud computing resources as a service, 2) receiving, from a customer of the cloud service brokering service, cloud service request information, 3) selecting, based on the cloud service request information, a cloud computing resource from the distinct sets of cloud computing resources provided by the plurality of cloud services registered with the cloud service brokering service, and 4) allocating the selected cloud computing resource for use by the customer. In certain examples, the allocating may be supported by the system configuring a customer network to support implicit and/or explicit transport requirements. Corresponding systems and methods are also described.

### BACKGROUND INFORMATION

Cloud computing technologies have fundamentally changed how information technology (IT) and/or other computing services are provided to businesses, individuals, and/or other entities, e.g., by shifting what was previously done in-house to the cloud. With this change, businesses, individuals, and/or other entities are increasingly looking to cloud computing services as a way to reduce infrastructure-related expenditures and increase productivity. In general terms, a cloud computing service conventionally refers to the delivery of computing resources, such as software, infrastructure, and/or storage, as a service, via a public or private network for access by a network-connected device (e.g., via the Internet in such a manner to be accessible by an internet-enabled device anywhere and at any time). Numerous different types of cloud computing services may be provided including Infrastructure as a Service (IaaS), Software as a Service (SaaS), and/or Platform as a Service (PaaS), depending on the specific needs of the businesses, individuals, and/or other entities.

As the popularity of cloud computing services has increased, so has the number of competing cloud computing service providers offering different cloud computing services. In a conventional cloud computing environment, a customer or potential customer of public cloud computing services has to evaluate and select cloud resources offered by cloud service providers by interacting with each of the cloud service providers. For example, if a customer desires to increase server capacity for a predetermined time period and wishes to research the server capabilities offered by different cloud service providers, the customer must separately consider the server capabilities offered by each of the different cloud service providers before determining which cloud service provider best meets the customer's needs. This may be burdensome and time consuming, and typically requires that the customer establish a relationship with each researched cloud service provider.

In addition, with the increased adoption of public cloud computing services, concerns exist regarding privacy and security for data transported to/from the cloud. Conventionally, data associated with public cloud computing services is transported over the public Internet, which undesirably subjects the data to risks of theft, unauthorized access, and/or corruption.

### BRIEF DESCRIPTION OF THE DRAWINGS

The accompanying drawings illustrate various implementations and are a part of the specification. The illustrated implementations are merely examples and do not limit the scope of the disclosure. Throughout the drawings, identical reference numbers designate identical or similar elements.

FIG. 1 illustrates an exemplary configuration that includes a cloud service brokering system according to principles described herein.

FIG. 2 illustrates exemplary components of the cloud service brokering system included in the system of FIG. 1 according to principles described herein.

FIGS. 3A and 3B illustrate an exemplary expansion of a customer network according to principles described herein.

FIG. 4 illustrates an alternate implementation of a customer network according to principles described herein.

FIG. 5 illustrates exemplary informational objects that may be provided in the customer domain according to principles described herein.

FIG. 6 illustrates exemplary informational objects that may be provided in the cloud service provider domain according to principles described herein.

FIG. 7 illustrates exemplary informational objects that may be provided in the cloud broker service system domain according to principles described herein.

FIG. 8 illustrates an exemplary cloud service brokering method according to principles described herein.

FIG. 9 illustrates another exemplary cloud service brokering method according to principles described herein.

FIG. 10 illustrates an exemplary computing device according to principles described herein.

### DETAILED DESCRIPTION OF PREFERRED EMBODIMENTS

Exemplary cloud service brokering systems and methods are disclosed. In certain embodiments, the exemplary systems and methods described herein may provide a broker service to one or more customers of the broker service. A customer of the broker service may submit a request for cloud computing resources to the broker service and receive, from the broker service in response to the request, access to cloud computing resources that have been dynamically selected from cloud computing resources associated with a plurality of cloud services registered with the broker service and allocated for use by the customer.

As an example, a cloud service brokering system that provides a cloud service brokering service may register a plurality of cloud services with the cloud service brokering service, the plurality of cloud services provided by a plurality of cloud service providers and configured to provide distinct sets of cloud computing resources as a service. The cloud service brokering system may receive cloud service request information from a customer of the cloud service brokering service, select, based on the cloud service request information, a cloud computing resource from the distinct sets of cloud computing resources provided by the plurality of cloud services registered with the cloud service brokering service, and allocate the selected cloud computing resource for use by the customer.

In this or another manner, the exemplary cloud service brokering systems and methods described herein may provide customers of the cloud service brokering service with a way to access and use cloud computing resources provided as a service by one or more cloud service providers. The customers may be able to access the cloud computing resources, from any of the cloud service providers registered with the brokering service by way of the brokering service, without having to establish a relationship with the cloud service providers or interact with user interfaces provided by the cloud service providers to separately research cloud computing resource capabilities, availability, and/or terms of use specific to each cloud service provider.

Additionally or alternatively, the exemplary cloud service brokering systems and methods described herein may manage and optimize the usage, performance, and/or cost of the cloud computing resources provided by the cloud service providers. For example, the systems and methods may manage and optimize an end-to-end cloud resource consumption cycle by monitoring cloud services provided by a plurality of cloud service providers (e.g., by monitoring allocation and usage of cloud computing resources provided by the cloud service providers) and allocating cloud resources to a customer of the brokering service based on the specific needs of the customer and/or the monitoring of cloud services. Accordingly, cloud computing resources provided by the cloud service providers may be allocated for use, by way of the brokering service, without the cloud service providers having to manage allocation of the cloud computing resources or establish relationships with or deal directly with the users of the cloud computing resources.

Additionally or alternatively, the exemplary systems and methods described herein may increase security of an end-to-end cloud resource consumption cycle, compared to an end-to-end cloud resource consumption cycle associated with conventional cloud services. For example, exemplary methods and systems described herein may modify a customer network to accommodate allocation of a selected cloud computing resource for use by a customer. The modifying of the customer network may comprise extending the customer network to support a connection between a customer computing system of the customer and the selected cloud computing resource. This allows for a dynamic extension of the customer's network to reach a cloud resource location without requiring separate provisioning processes and/or without transporting cloud service data by way of a public network.

These and additional or alternative benefits and/or advantages that may be provided by one or more of the exemplary systems and methods described herein will be made apparent herein. Exemplary cloud service brokering systems and methods will now be described in reference to the drawings.

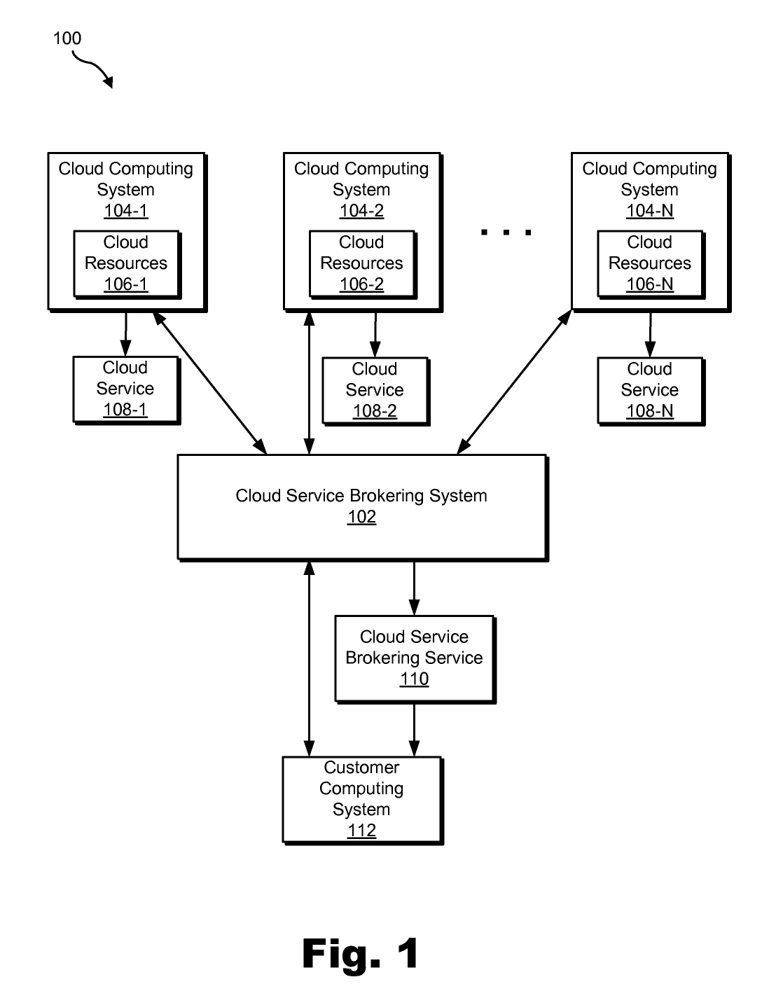

FIG. 1 illustrates an exemplary configuration 100 that includes a cloud service brokering system 102 (or simply “brokering system 102”). As shown in FIG. 1, configuration 100 may include multiple cloud computing systems 104 (e.g., cloud computing systems 104-1 through 104-N) that include distinct sets of cloud computing resources 106 (or simply “cloud resources 106”) (e.g., cloud resources 106-1 through 106-N) and provide cloud services 108 (e.g., cloud services 108-1 through 108-N). In certain examples, the configuration 100 may be provided in a cloud environment that includes any combination or sub-combination of standard cloud types such as private, public, community, and hybrid cloud types.

A cloud service provider may manage (e.g., operate) one or more of the cloud computing systems 104 and, using the cloud resources 106 provided by the cloud computing systems 104, offer the cloud services 108 to businesses, individuals, and/or other entities. A cloud service provider may be any entity that offers some component of cloud computing—such as IaaS, SaaS, or PaaS—to businesses, individuals, and/or other entities as a service (e.g., as a public cloud service accessible via a public network). An example of such a cloud service provider is Amazon Web Services, which provides multiple different cloud-based services including, for example, messaging services, database services, networking services, and storage services. Additionally or alternatively, a cloud service provider may be an entity that offers a private cloud service (e.g., a private cloud service implemented through VMware, OpenStack, etc.) for use by businesses, individuals, other entities, and/or by the cloud service provider itself. In a configuration in which the cloud service provider provides a private cloud service for use by the cloud service provider, the cloud service provider may be considered a customer of the private cloud service.

In certain examples, each of the cloud computing systems 104 shown in FIG. 1 is managed by a different cloud service provider. As a group, the cloud service providers may provide only public cloud services, only private cloud services, or a combination of public and private cloud services. Accordingly, as described herein, brokering system 102 may broker access to any of these combinations of cloud services.

The cloud computing systems 104 may each provide one, or more than one, cloud service 108 depending on the cloud resources 106 that are available. For example, the cloud services 108 may be configured to provide one cloud resource 106 or distinct sets of the cloud resources 106 as a service. As used herein, “cloud resources” refer to any computing resource that may be provided as a service by a cloud service provider. For example, cloud resources 106 may include user and system account resources, data transport resources, memory resources, processing resources, and/or any other computing resources provided by cloud service providers. Examples of cloud resources 106 may include central processing units (CPUs), virtual machines, memory, storage, switches, databases, platforms, servers (e.g., application servers), etc. Cloud resources 106 are typically located off-site or otherwise remote from a customer who uses the cloud resources 106 as a service.

A “cloud service” refers to any service by way of which access to and use of computing resources as a public or private service is provided by a cloud service provider. For example, cloud services 108 may include any one of IaaS, SaaS, and PaaS. With IaaS, a cloud service provider maintains physical computing resources that are provided as the service, including computing resources such as servers, networks, data storage devices, and hosting infrastructure. The physical computing resources may be accessible through computing resource abstractions, such as virtual machines or virtual user interfaces. With SaaS, the cloud service provider maintains, implements, updates, and configures the operation of software applications on the cloud network infrastructure such that the software applications may be provided as a service. With PaaS, the cloud service provider manages the computing infrastructure for the platform and runs the software that provides the components of the platform, such as databases and/or other middleware components.

Each cloud computing system 104 may include and/or be implemented by one or more suitable physical computing devices configured to perform one or more operations to provide the respective cloud resources 106 as a cloud service 108, as described herein. For example, each cloud computing system 104 may include and/or be implemented by any number of computing devices and/or systems such as one or more server devices, data centers, etc. configured to host and provide cloud resources 106 for use as a service.

The brokering system 102 may be communicatively coupled to the cloud computing systems 104 and may include and/or be implemented by one or more suitable physical computing devices configured to perform one or more operations of the brokering system 102 described herein. For example, the brokering system 102 may include and/or be implemented by any number of computing devices and/or systems such as one or more server devices, network devices, data centers, etc. Brokering system 102 may be implemented by and/or as a computing platform that is separate and/or independent of computing platforms that implement cloud computing systems 104.

The brokering system 102 may be configured to register the cloud services 108 provided by the cloud computing systems 104 for participation in a cloud service brokering service 110. The cloud services 108 may be registered with the cloud service brokering service 110 by the brokering system 102 in any way suitable to facilitate the cloud services 108 being accessible to one or more businesses, individuals, and/or other entities by way of the cloud service brokering service 110. For example, the brokering system 102 may register the cloud services 108 by receiving one or more registration requests from cloud service providers and processing the requests such that the brokering service 110 is configured to provide customers with access to and use of cloud resources 106 provided by the cloud service providers as a service. The registration information may include any information about the cloud resources 106, cloud services 108, and/or any other information that may be used to register the cloud services 108 and provide customers of the brokering service 110 with access to and usage of the cloud resources 106. In certain examples, the registering may be accompanied by the cloud service providers entering into a service agreement or information sharing agreement with a provider of the brokering service 110 and in which the cloud service providers agree to provide, via the cloud computing systems 104, up-to-date information regarding the cloud resources 106 and/or the cloud services 108 provided through the cloud computing systems 104. The information provided through the cloud computing systems 104 may be used by the brokering system 102 to maintain data representative of (e.g., a real-time database of) the cloud resources 106 and/or cloud services 108 currently available for use from the cloud computing systems 104. For example, the data may include information regarding cloud resources 106, their capabilities, usage, and/or other attributes. The data may be updated by the brokering system 102 communicating with the cloud computing systems 104 in any suitable manner to obtain updated information about the cloud resources 106.

The brokering system 102 may be further configured to provide the cloud service brokering service 110 to a customer or other user of the cloud service brokering service 110. The cloud service brokering service 110 may be accessible to the customer by way of a customer computing system 112 associated with (e.g., operated by) the customer. While FIG. 1 shows a single customer computing system 112, this is illustrative only. The brokering system 102 may support multiple customers associated with multiple customer computing systems. Accordingly, the brokering system 102 may function as a multi-tenant brokering system 102.

The customer computing system 112 may include and/or be implemented by one or more suitable physical computing devices configured to perform one or more operations of the customer computing system 112 described herein. For example, the customer computing system 112 may include and/or be implemented by any number of computing devices and/or systems such as personal computers, mainframe computers, server devices, and/or any other computing device that may be used by the customer to access the cloud service brokering service 110, including by accessing cloud resources 106 as a service through cloud service brokering service 110 and using the cloud resources 106 for one or more purposes of the customer.

In certain examples, the customer of the cloud service brokering service 110 may utilize customer computing system 112 to provide cloud service request information to the brokering system 102, such as by transmitting data representative of the cloud service request information to the brokering system 102 in any suitable way. “Cloud service request information” refers to any information related to services that the customer may want to use. For example, the cloud service request information may include a request for a specific number of servers, a request for a specific amount of data capacity, or a request for specific services such as IaaS, SaaS, and PaaS.

Based on the cloud service request information received from the customer computing system 112, the cloud service brokering system 102 may select and allocate one or more cloud resources 106 of one or more of the cloud services 108 registered with the cloud service brokering service 110 for use by the customer. Examples of the cloud service brokering system 102 selecting and allocating cloud resources 106 for user by a customer of the cloud service brokering service 110 are described herein.

Components of configuration 100, such as the cloud service brokering system 102, the cloud computing systems 104, the cloud resources 106, and the customer computing system 112, may communicate with one another using any suitable communication technologies, devices, media, protocols, and/or networks supportive of data communications, including, but not limited to, the Internet, intranets, local area networks, wide area networks, other communications networks, data transmission media, communications devices, network elements, Transmission Control Protocol (TCP), Internet Protocol (IP), File Transfer Protocol (FTP), Telnet, Hypertext Transfer Protocol (HTTP), Simple Object Access Protocol (SOAP), Extensible Markup Language (XML) formatted messages, service calls (e.g., web service calls), remote portal technologies (e.g., Web Services for Remote Portlet (WSRP) technologies, socket connections, Ethernet, data and/or service bus technologies, service-oriented architecture technologies, and other suitable communications technologies.

While an exemplary configuration 100 is shown in FIG. 1, the exemplary components illustrated in FIG. 1 are not intended to be limiting. Other components and/or configurations of components may be used in other implementations. Exemplary components of configuration 100 will now be described in additional detail.

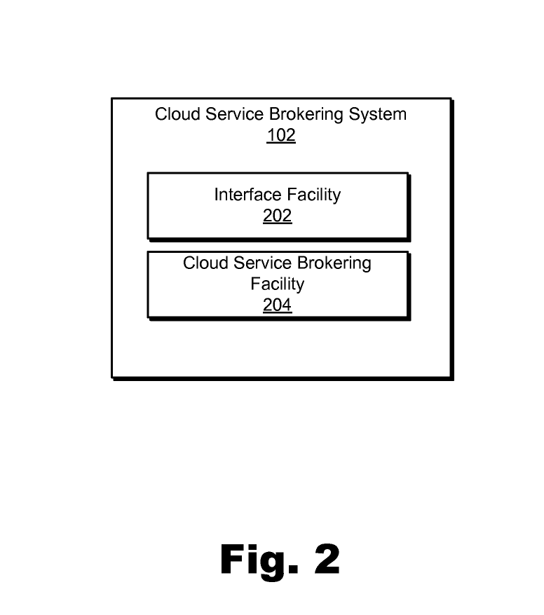

FIG. 2 illustrates exemplary components of brokering system 102 that may provide the cloud service brokering service 110. As shown in FIG. 2, the brokering system 102 may include an interface facility 202 and a cloud service brokering facility 204, which may be in communication with one another using any suitable communication technologies. One or more of facilities 202 and 204 may include or be implemented by one or more computing devices and/or processors configured to perform one or more of the functions described herein.

The interface facility 202 may be configured to provide one or more user interfaces through which cloud service providers and customers of the brokering service 110 may interact with brokering system 102 and/or access brokering service 110. In certain examples, the interface facility 202 may provide a provider-facing user interface (e.g., a web portal) for access and use by the cloud service providers and a customer-facing user interface (e.g., the same web portal or a separate web portal) for access and use by the customers of the brokering service 110. Through such user interfaces, the brokering system 102 may receive information from and/or provide information and/or options to the cloud service providers and/or the customers of the brokering service 110.

In certain examples, the interface facility 202 may provide an interface such as one or more graphical user interfaces (GUIs), command line interfaces (CLIs), and/or application program interfaces (APIs) configured to facilitate the registering of the plurality of cloud services 108 provided by a plurality of cloud service providers and the receiving of the cloud service request information provided by the customer. The one or more GUIs, CLIs, and/or APIs may be accessed by the cloud computing systems 104, the customer computing system 112, and/or any authorized computing device remote of and communicatively coupled to the broker system 102.

Using information received from cloud service providers by way of an interface (e.g., a user interface), the interface facility 202 may be configured to receive and use registration information to register the cloud services 108 provided by the cloud service providers with the brokering service 110. By way of example, the interface facility 202 may provide a web portal, a CLI, and/or an API through which a cloud service provider may provide registration information for receipt and use by the interface facility 202 to register one or more cloud services 108 with the brokering service 110. To this end, the cloud service provider may access the web portal, CLI, and/or API to set up a user account with the broker system 102. With an account set up, the cloud service provider may provide information regarding the cloud services 108 and/or cloud resources 106 provided by the cloud service provider. Such information may include information regarding, for example, IaaS, SaaS, or PaaS services provided by the cloud service provider as well as any other information that may be useful to identify the cloud service provider, the available cloud services 108, cloud resources 106, the capabilities, availability, and/or other attributes of the cloud services 108 and/or cloud resources 106, and/or cloud service provider requirements or preferences for allocation, usage, costs, and/or revenues of the cloud services 108 and/or cloud resources 106.

After receiving registration information and an accompanying request from a cloud service provider, the interface facility 202 may perform one or more operations to use the information to register one or more cloud services 108 with the brokering service 110. This may include storing, to a data store, data representative of information about the cloud services 108 and associated cloud resources 106 to a data store, as well as any of the information that may be used by the cloud service brokering facility 204 to broker the cloud services 108 as described herein.

The interface facility 202 may allow customers to access multiple different cloud services and/or resources through a single interface, such as by entering cloud service request information along with a request for use of cloud resources as a service. To this end, the interface facility 202 may be further configured to receive information from a customer of the brokering service 110, such as cloud service request information provided by a customer of the brokering service 110 and associated with a request to access cloud resources as a service. The cloud service request information may specify customer requirements and/or preferences for cloud resources, such as information specifying cloud processing capabilities (e.g., processing capabilities desired by a customer), cloud transportation characteristics (e.g., data transfer characteristics desired by a customer), and/or any other information that may suit the customer's cloud computing requirements and/or preferences. In one implementation, this may be accomplished by the customer accessing a web portal and providing any information related to cloud services and/or resources that the customer may want to use.

The cloud service brokering facility 204 may be communicatively coupled to the interface facility 202 in any suitable manner and may be configured to broker the cloud services 108 registered with the cloud service brokering service 110. As used herein, “to broker” refers to an arranging of cloud resources transactions and/or cloud services transactions between a provider of cloud services and a consumer of cloud services (e.g., between a cloud service provider and a customer of the cloud service brokering service 110) by an entity (e.g., the cloud service brokering facility 204). The arranging of the transactions may include the brokering system 102 dynamically selecting and allocating one or more of the cloud resources 106 for use by the consumer. As noted above, the cloud resources 106 provided by the cloud service providers may be allocated for use, by way of the cloud service brokering service 110, without the cloud service providers having to manage allocation of the cloud resources 106 or establish relationships with or deal directly with the users of the cloud resources 106.

The cloud service brokering facility 204 may select, based on the cloud service request information received by the interface facility 202 as described above, a particular cloud computing resource 106 from the distinct sets of cloud resources 106 provided by the plurality of cloud services 108 that are registered. For example, the cloud service brokering facility 204 may compare any of the cloud service request information to data maintained about the cloud services 108 registered with the brokering service 110 to identify, based on the comparison, that the particular cloud computing resource 106 is available and appropriate to meet the needs and/or preferences of the customer specified in the cloud service request information. Such a comparison may take into account any requirements and/or preferences specified by the cloud service request information and any attributes of the cloud resources 106 and/or cloud services 108 registered with and managed by the brokering service 110, including processing capabilities, transportation characteristics, resource costs, resource availability, resource location, etc.

To illustrate, in certain examples, the cloud service request information may specify a class of traffic to be used for data transfer in relation to the use of computing resources as a service. For example, the customer may specify that a particular class of traffic is to be used to transport data traffic with a predetermined amount or less of packet loss to ensure a desired level of performance. This may be particularly desirable when the traffic to be transported is associated with, for example, streaming technologies, voice over IP, online gaming, and/or videoconferencing in which packet loss results in noticeable performance issues and/or jitter. In some implementations, the particular cloud computing resource 106 may be selected by the cloud service brokering facility 204 based at least in part on the class of traffic specified in the cloud resource request information.

After selecting the particular cloud computing resource 106, the cloud service brokering facility 204 may allocate the selected cloud computing resource 106 for use by the customer. The cloud service brokering facility 204 may allocate the selected cloud resource 106 by making the selected cloud resource 106 accessible to the customer either through the customer computing system 112 or through any other authorized computing device. For example, the customer may be able to access the allocated cloud computing resource through an authorized mobile device that is communicatively coupled to the customer computing system 112.

The cloud service brokering facility 204 may be configured to allocate the selected cloud resource 106 for use by the customer in any suitable way. For example, the cloud service brokering facility 204 may reserve the cloud resource 204 for use by the customer during a particular time period, indefinitely, or as may suit the needs and/or preferences of the customer and in a manner that ensures that the cloud resource 106 is available to the customer. The cloud service brokering facility 204 may further provide information to the customer that may be used by the customer and/or the customer computing system 112 to access and use the cloud resource 106. For example, the cloud service brokering facility 204 may provide information to be used by the customer computing system 112 to communicate with and/or gain access to the computing resource 106.

Once the cloud resource 106 is allocated, the customer computing system 112 may communicate with, access, and/or use the cloud resource 106 as a service. The cloud service brokering facility 204 may be configured to monitor and/or otherwise manage the allocation and use of the cloud resource 106.

The cloud service brokering facility 204 may be configured to withdraw the allocation (e.g., make inaccessible) of the selected cloud resource 106 for use by the customer. For example, at an end of a time period for the allocation (e.g., a predetermined amount of time that may be specified in advance by the customer, such as in the cloud service request information), the cloud service brokering facility 204 may end the allocation of the cloud resource 106 to the customer.

In one example, a retail commercial electronics seller that is a customer of the brokering service 110 may anticipate increased server load due to the launch of a new electronic device. The cloud service brokering facility 204 may, based on cloud service request information provided by the retail commercial electronics customer, select and allocate (e.g., make accessible) cloud resources 106 in the form of servers from one or more cloud computing systems 104 to dynamically satisfy the customer's anticipated cloud computing needs. After a predetermined amount of time, the cloud service brokering facility 204 may withdraw the allocation of the selected cloud resources 106. This allows the cloud service brokering facility 204 to dynamically scale up, for example, server capacity for a predetermined amount of time to meet a specific customer need and scale down the server capacity after completion of the predetermined amount of time, thus optimizing usage and reducing cost of cloud services. The cloud service request information in this exemplary implementation may include, for example, information related to desired server capacity, desired geo-location of cloud resources 106, and/or the timing of the launch of the new electronic device. In some implementations, the cloud service brokering facility 204 may automatically withdraw the selected cloud resources 106 based on information indicating that the increased server capacity is no longer needed. Such information may include current server usage, anticipated server usage, and/or the time of day.

In another example, a media content provider that is a customer of the brokering service 110 may anticipate increased user storage activity due to an upcoming sporting event, political event, or some other event that may require increased storage capacity for a predetermined amount of time. The cloud service brokering facility 204 may, based on cloud service request information provided by the customer, select and allocate cloud resources 106 in the form of storage from one or more cloud computing systems 104 to dynamically satisfy the customer's cloud computing needs. The cloud service request information in this example may include, for example, information regarding a desired amount or types of storage (e.g., SDD, magnetic storage, optical storage, etc.), capacity (e.g., number of bytes), read/write performance, and timing of the upcoming event.

In some implementations, the cloud service brokering facility 204 may be configured to actively manage the allocated cloud resources 106, which management may include logging information related to the allocation and/or use of the cloud resources 106. For example, the cloud service brokering facility 204 may log information related to a duration and/or frequency of use of the cloud resources 106, which may be used to optimize the selection, allocation, and use of the cloud resource 106. Based on the logged information, the cloud service brokering facility 204 may be configured to generate a history of one or more of the cloud resources 106, which history may be provided to a customer and/or cloud service provider through the interface facility 202. By generating the history, the cloud service brokering facility 204 may facilitate cloud service providers and/or the customer using the information to analyze different aspects of the cloud resources 106 and identify opportunities to improve efficiencies related to the allocation and/or use of those resources.

The history generated by the cloud service brokering facility 204 may include information regarding one or any combination of a category of the cloud computing resources, a cost of the cloud computing resources, the cloud service provider(s) that provided the cloud computing resources, a customer that received the cloud computing resources, locations of the cloud computing resources, cloud computing resources utilization statistics, accounting information, and an application type of the cloud computing resources. To illustrate, the categories of cloud resources 106 may include storage resources, switch resources, database resources, platform resources, server resources, etc. The cost of the cloud resources 106 may include either one or both of a cost that a cloud service provider may incur in providing cloud resources 106 as a service and a cost that the consumer may incur in using the cloud resources 106 through the cloud service brokering service 110. The information in the history related to the cloud service provider(s) that provided the cloud resources 106 and the customer that received the cloud resources 106 may include, for example, names as well as any other identifying information of the cloud service providers and/or customers. The location information of the cloud computing resources provided in the history may include a physical geo-location and/or a network address location of the cloud resources 106. The cloud computing resources utilization statistics may include information such as a duration, frequency of use, and/or reliability of the cloud resources 106, as well as any other information regarding how the cloud resources 106 are used. The accounting information included in the history may include any information related to, for example, past billing statements, payment history, and/or payment tendencies of the customer and/or cloud service provider. The application type of the cloud resources 106 may refer to how the particular cloud resources 106 were applied by the customer. For example, the history may include information indicating that the allocated cloud resources 106 included storage resources that were applied by the customer to increase email storage capacity.

In some implementations, the cloud service brokering facility 204 may be configured to configure (e.g., modify) a customer network to accommodate the allocating of a selected cloud computing resource 106 for use by a customer. The configuration of the customer network may include any change to the customer network to support implicit and/or explicit transport requirements, which may include transport requirements to support the allocation and/or use of the cloud computing resource 106 as explicitly and/or implicitly defined by cloud service request information. The customer network may be any suitable type of network associated specifically with the customer and that may be flexibly modified to reach new and/or different network locations. For example, in one implementation, the customer network may comprise a private network such as a virtual private network (VPN) in which some of the links between nodes are carried by open connections or virtual circuits in some larger network (e.g., the Internet) instead of by physical wires. This allows the customer to protect data traffic that is exchanged between cloud resources 106 and multiple cloud locations over a non-public network, thus increasing security. The customer network may be a private cloud network or may be a hybrid cloud network (e.g., a composition of two or more clouds (private, community, or public clouds)).

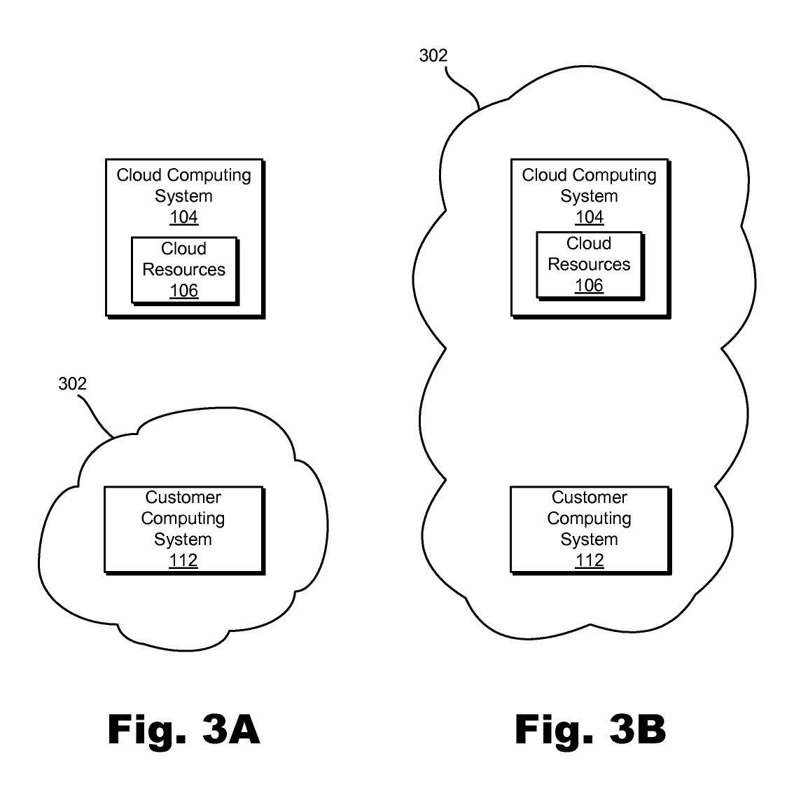

FIGS. 3A and 3B show an exemplary modification of a customer network 302 in which the customer network 302 is extended to support a connection between the customer computing system 112 and selected cloud resources 106. As shown, in FIG. 3A, the customer network 302 encompasses the customer computing system 112 but not the cloud resources 106 in the cloud computing system 104. In FIG. 3B, the customer network 302 has been extended and now encompasses the customer computing system 112 and the cloud resources 106 in the cloud computing system 104. This allows a customer network connection to be established between the customer computing system 112 and the cloud resources 106 in the cloud computing system 104 and used by the customer computing system 110 to access and use the cloud resources 106 in a manner that associated data transfer is carried by the network connection.

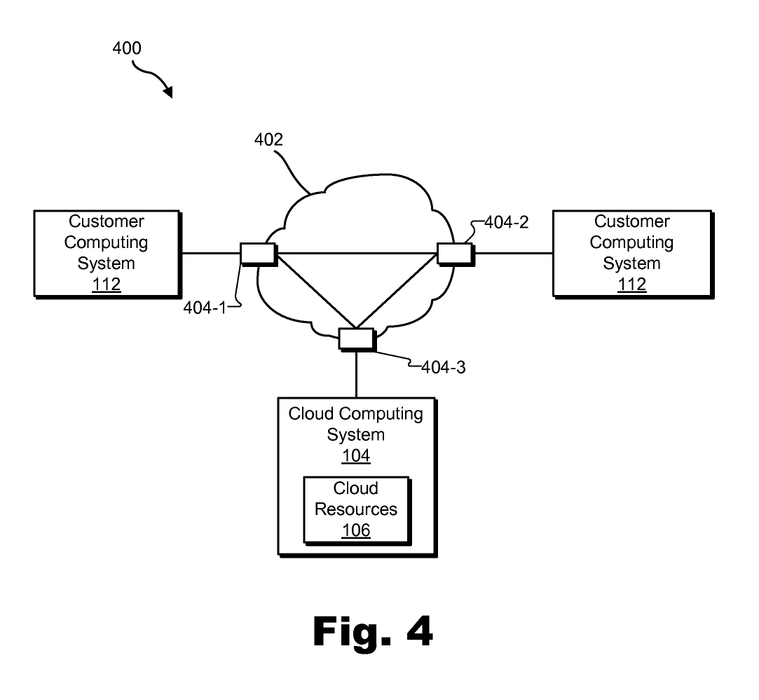

FIG. 4 illustrates a configuration 400 in which a customer network may be modified to accommodate the allocating of the selected cloud computing resource 106. As seen in FIG. 4, customer computing system 112 may be communicatively connected via a private customer network 402 through network interface devices 404-1 and 404-2. To support the allocating of selected cloud resources 106 for use by a customer associated with the customer computing systems 112, the private customer network 402 may be modified to connect to the cloud computing system 104 and the selected cloud resources 106 through network interface device 404-3 to either one or both of customer computing systems 112. In so doing, data traffic that may be exchanged over a non-public network between cloud computing system 104 and one or more customer computer systems 112 may be protected, thus increasing security.

The cloud service brokering facility 204 may modify the customer network in any suitable way. In some embodiments, the cloud service brokering facility 204 may communicate with a customer's private network system to initiate the private network system modifying (e.g., extending) the customer's network (e.g., by triggering an existing provisioning process instead of the cloud service brokering facility 204 actually doing the provisioning). In certain examples, a provider of the brokering service 110 may be the same entity as, or an entity that has an established relationship with, an entity that provides the customer's network. Based on this, cloud service brokering facility 204 may have access to the customer's network to initiate modification of the customer's network.

In some implementations, the cloud service brokering facility 204 may be configured to offer management services, analytics services, and/or intelligence services for customers of the cloud service brokering service 110 and for cloud service providers. These generated management services, analytics services, and/or intelligence services may be provided to the customers and/or cloud service providers through the interface facility 202. The cloud service brokering facility 204 may, through the management services, be configured to manage the cloud resources 106 on behalf of the cloud service providers and the customers. The cloud service brokering facility 204 may, through the analytics and intelligence services, allow both cloud service providers and customers to examine the efficiency, effectiveness, and/or any behavior that may be of interest relating to cloud resource and/or service usage. An exemplary manner in which the cloud service brokering facility 204 may provide these services is set forth in the following description.

In certain examples, cloud service brokering facility 204 may include and/or be implemented as a service architecture configuration of functional modules, which may be categorized as management functional modules, analytics functional modules, and intelligence functional modules, each of which are described in detail below. As used herein, a “user” of the cloud service brokering facility 204 refers to either one or both of a cloud service provider and a customer of the cloud service brokering service 110.

Management Functional Modules—

This group of modules may provide various cloud resource management functions. The management functions may be useful in different phases of a cloud consumption cycle from cloud resource procurement, configuration, consumption, monitoring, and to release of cloud resources 106.

Analytics Functional Modules—

This group of modules may support analytics and data mining functions for the user's cloud environments. For example, a cloud service provider may use the analytics group of modules to optimize the cloud service provider's resource utilization and performance. The customer, on the other hand, may use the analytics group of modules to examine the customer's cloud resource effectiveness and/or cloud application performance.

Intelligence Functional Modules—

By leveraging the management and analytics functional modules, the cloud service brokering facility 204 may support different intelligent functions to enhance the overall cloud experience. For example, the cloud service brokering facility 204 may search cloud resources 106 that meet multiple selection criteria for a specific application. The cloud service brokering facility 204 may also act as an agent for the customer to automate complex cloud tasks such as dynamic application deployment and security audits. Additional modules may include common cloud tasks such as an application disaster recovery agent, a dynamic load balancing agent, an application element redistribution agent, an application element relocation agent, wide area network (WAN) optimization, etc.

The cloud service brokering facility 204 may include various management functional modules as may serve a particular implementation. Such management functional modules may include a system account profile manager, a network resource procurement manager, a compute resource procurement manager, a configuration manager, a log manager, an exception manager, a capacity/usage/performance manager, a security manager, a cost manager, and a report manager. Each of these management functional modules will now be described.

System Account Profile Manager—

This module may be responsible for managing user and system account information. User accounts may govern a user's access to various features and information of the cloud service brokering facility 204. Each user's access privilege may be maintained in a user profile. The system account profile manager may support user role assignment and/or privilege inheritance features. All user profile management activities may be logged in files that may be retrieved at a later time. System accounts may be used by the users to access external systems of the cloud service brokering facility 204. In certain implementations, each system account may be treated like a Unix file on the platform that its access (read, write, modify and execute) operations are governed according to the access privileges of the user.

Network Resource Procurement Manager—

This module may be responsible for managing a telecommunications service provider's (e.g., a carrier's) transport resources between cloud locations. These resources may be procured dynamically by a user to meet the common elastic scaling requirements of cloud computing. Network resources may be typically specified in terms of bandwidth and/or class of service (CoS). Changing these parameters may cause changes in the capacity of the network resources. The network resource procurement manager may keep track of the changes a user makes to these resources, verify that the user is authorized to make the changes based on the privilege setting in his/her user profile, and update cost and accounting information.

In addition to procuring the carrier resources, a user may also procure network service resources such as virtual servers, edge routers, WAN optimizers, DNS, Firewall, etc. These resources may allow the customers to transport cloud traffic more efficiently and securely. The module may manage this type of resources procurement as the transport resources.

Compute Resource Procurement Manager—

This tool may be responsible for managing procurement of computing resources from cloud service providers. These resources may include CPU, virtual memory, memory, storage, switches, databases, platforms, service servers, etc. Like the network resource procurement manager, the compute resource procurement manager may support the cloud resource consumption processes from procurement to release. The compute resource procurement manager may log the details of each transaction, maintain an up-to-date inventory of all the resources acquired and leftover, and update cost and accounting information for both the customer and the cloud service provider.

Configuration Manager—

This module may be responsible for configuring network and computing resources procured by a customer or returned by a customer to a cloud service provider. This module may allow a user to configure both network and computing resources dynamically. Different interfaces such as command line terminal session, GUI, and/or scripted sessions may be supported. This module also may monitor the progress of a configuration process and generate logs for each configuration session.

Log Manager—

This module may be responsible for collecting log information from both network and computing resources. Log files may come from flow data (e.g., NetFlow data, JFlow data, sFlow, Internet Protocol Flow Information Export (IPFix) data, etc.), syslog, simple network management protocol (SNMP) messages, server logs, and application logs or any other sources as specified by the user. The log manager may keep track of the log files and may present basic log content in text or graphical forms to the user.

Many logs may have specific formats and use different protocols for data exchange. The log manager may be configured to handle each log separately with respect to log retrieval methods, storage organization, downloading schedule, encrypting data, setting up access permission, etc. Once the logs are downloaded, the user may define different treatments for the logs such as storage time, storage threshold, locations, redundancy, encryption, and download methods, etc.

Exception Manager—

The exception manager may be responsible for collecting exception notifications and managing exception events. The cloud service brokering facility 204 may, through the interface facility 202, allow users to specify exception conditions and exception handling actions on different cloud resources. The exception conditions are typically detected by target cloud resources and reported back to the module. Upon receiving of an exception notification, the exception manager module performs the associated exception handling actions as defined by the user. These actions may include sending notifications to personnel and remote systems and/or executing some pre-defined scripts. The occurrence, treatment, and progress of all exception events may be logged in the system. Additionally or alternatively, this module may provide aggregated views of different groups of exception conditions, their occurrences, and exception handling logs.

Capacity/Usage/Performance (CUP) Manager—

The CUP module may be responsible for reporting various metrics of the cloud resources 106. The CUP module may allow a user to view different types of CUP related information such as cloud resource availability, utilization, and performance metrics. With respect to transport and network resources, some example performance metrics may include: time to change access bandwidth; time to change CoS traffic profile; packet delay for each class of traffic over time and different source/destination pairs; delay variance for each class of traffic over time and different source/destination pairs; packet loss for each class of traffic over time and all source/destination pairs; throughput of service traffic; queue length of different types of traffic; response time of service requests; activation time for a provider edge—customer edge (PE-CE) connection; activation time for a provider edge—provider edge (PE-PE) connection; activation performance of virtual network servers (firewall, NAT server, DNS, etc.); and rebooting time for virtual network servers.

Some examples of capacity metrics for transport and network resources may include: transport capacity; bandwidth capacity; different types of transport service; load carrying capacity for different types of virtual network servers; CPU types for each device; memory for each device; and storage capacity.

Some examples of utilization metrics for transport and network resources may include: traffic volume for each type of traffic between different locations; link utilization for each interface or each location; service load on different virtual network servers; CPU usage over time for each device; memory usage over time for each device; and storage usage over time for each device

With respect to compute resources, some exemplary performance metrics may include: response time for CPU/memory requests; response time for storage requests; response time for configuring a virtual memory; different benchmark test results; CPU rebooting frequency; and CPU rebooting time.

Some examples of capacity metrics for compute resources may include: number of free, allocated, reserved CPU virtual machine (VM) of a different number of cores; amount of free, allocated, reserved memory; and amount of free, allocated, reserved local storage.

Some examples of utilization metrics for compute resources may include: input/output (I/O) traffic rate per CPU or VM; I/O traffic rate per interface; I/O traffic rate per virtual local area network (VLAN); CPU usage over time for each device; memory usage over time for each device; and storage usage over time for each device.

With respect to storage resources, some exemplary performance metrics may include: raw data access performance; benchmark tests for different types raw storage devices; benchmark tests for different file systems; benchmark performance for different types of database systems for transactional and non-transactional applications; and system failure frequency.

Some examples of capacity metrics for storage resources may include: raw storage capacity in each location; formatted storage capacity; allocated capacity; reserved capacity; free capacity; raw storage capacity availability schedule; capacity for different types of file systems; and capacity for different types of database systems.

Some examples of utilization metrics for storage resources may include: disk access frequency distribution; disk access pattern; file system used/free space; percentage of different types of files; file access frequency for different types of files; file access pattern (random, sequential, read, write, change mode); database used size; database usage pattern (transaction, query, logging, administrative, etc.); and sizes of different tables, rows and/or columns.

To compute the above metrics, the CUP module may work with other modules of the cloud service brokering facility 204 to extract the needed data for use in calculating the metrics. The user may request the metrics be computed on-demand, ad hoc, or continuously. In some implementations, the results of the metrics may be saved in a report and/or provided for export.

Security Manager—

This module may be responsible for monitoring and enforcing security policies specified by users. Security policies may be specified by users on different platform entities. These entities may include user profiles, resources, reports, logs, and access privilege to different functions. The module may interwork with external security systems such as lightweight directory access protocol active directory (LDAP/AD), single sign on (SSO), or other security authentication servers to allow providers and customers to leverage their existing security infrastructures. All security policies may be enforced until some override actions (e.g., permitting a temporary user privilege) are taken by the users with an appropriate privilege level.

A user may also request the security manager to monitor security events such as unsuccessful login events, user profile change events, access to certain functions or data objects, etc., and to record the events in a log. If these events exceed some thresholds, for example too many unsuccessful login attempts, the module may notify the exception manager module for immediate actions.

Cost Manager—

This module may control and manage cloud resource spending. The cost manager may monitor and limit how much and what resources each user may purchase. The cost manager may also maintain resource pricing information for each cloud resource. In addition, the cost manager may update running cost information for user groups or accounting codes. Budgets may be assigned to user and/or accounting codes to control cloud resource spending. The cloud resource spending and earning information for customers and cloud service providers, respectively, may be organized by resource type, period, location, and/or user defined tags.

Report Manager—

This module may be responsible for generating different views of information generated by the cloud service brokering facility 204, which views may be provided to the user through the interface facility 202. The user may extract the part of information of interest by specifying filtering criteria for each data set. The filtering criteria may include time, duration, resource type, resource location, users, selected data fields, etc. The filtering criteria may be saved for reuse. Once the data selection criteria are defined, the user may choose a pre-defined template to present the information. The report may be viewed online, saved as a document, and/or transferred out via different protocols such as email or secure shell (SSH) file transfer protocol (SFTP), etc. The report manager may also allow users to schedule reports to be pulled in advance according to a pre-defined schedule or to be generated on a regular schedule. It will be understood that any data required as input of the report manager or generated by the report manager may be subject to the purview of the established security policies.

The cloud service brokering facility 204 may include various analytics functional modules as may serve a particular implementation. Such analytics functional modules may include a log analyzer, a resource analyzer, a spending/earning analyzer, a workload analyzer, a topology analyzer, and a cloud mining server. Each of these analytics functional modules will now be described.

Log Analyzer—

This module may be responsible for supporting basic analytics functions on logs and event messages collected by the cloud service brokering facility 204. The log analyzer may allow the user to view, format, sort, search, and apply different statistical analysis functions on each data set. Users may also compare different data sets and apply correlation analysis on them. Results may be saved as reports for export and/or storage in any suitable manner.

Resource Analyzer—

This module may be used to analyze the use of cloud resources for both customer and cloud service provider groups. This module may allow a user to examine the history of allocated cloud resources and the efficiency of their use. In some implementations, the resource analyzer may compile related information about the resources such as cloud computing resource category, cost of a cloud computing resource, cloud service provider that provided the cloud computing resource, the customer that received the cloud computing resource, location of the cloud computing resource, cloud computing resource utilization statistics, accounting information, application type of the cloud computing resource, etc. With the resource analyzer, the user may analyze different aspects of the cloud resources and identify any opportunity to improve efficiency of the cloud resources.

Spending/Earning Analyzer—

This module may provide a comprehensive cost breakdown structure on cloud spending/earning. The module may extract the spending/earning information from the various log files in which the spending occurs. The spending/earning information may be identified in different resource and service categories such as, for example, transport, virtual application server, service gateway, compute, storage, databases, platform time, time period, etc. The spending/earning information may also be aggregated for different locations, cloud service provider/customer, accounting codes, etc. With this module, the user may be able to analyze different spending trends and examine the efficiency of cloud spending/earning.

Workload Analyzer—

This module may analyze characteristics of cloud workloads as carried by a collection of cloud resources. The workload analyzer may extract information from various logs generated by different resources carrying the workloads. Each type of resource may generate a different set of workload characteristic measures. For example, a transport resource may capture traffic information related to data exchanged over a transport network; a compute resource may capture CPU load, memory usage, paging frequency, storage access frequency, etc.; a storage resource may capture frequency of read or write, random or sequential access, locality of access, average access size, etc.; and a database resource may capture frequency of different types of transactions. The workload analyzer may compile the log information for each resource in the same time scale. With this module, the user may identify potential resource bottlenecks or areas where resources are underutilized. Both types of conditions allow the user to improve performance and/or efficiency of the cloud use.

Additionally or alternatively, the workload analyzer may be directed to examine an internal state of each workload (such as an application or process). This assumes that the application/process has been coded with traps to report its state information such as program location, message queue length, message arrival time/rate, transaction time, etc. to a log file. The information may be compiled in a time scale to show potential performance bottlenecks.

Topology Analyzer—

This module may present different views of the cloud resource topology. There may be three generic horizontal topology views: physical, logical, and functional layers. The physical layer may capture information such as geo-locations (like regions, zones, racks, etc.), inventory, capacity, identification, and/or status of the physical resources. The logical layer may cover information on, for example, network routes, interfaces, local area network (LAN) segments, cluster of virtual memory (blocks, pools, packages), operation system (OS) environments (Linux, Windows etc.), storage structures (object storage, block storage, etc.), databases (structured query language (SQL), non-SQL,), etc. The functional layer may include information about, for example, traffic flows, processes, workload, persistent data sets, applications, etc.

In addition, there may be vertical topology views. These views may be defined either from physical resources and up the layers or from applications down the layers. A vertical view of a cloud application, for example, may depict all the entities (e.g., processes and data) or resources (e.g., utility servers and networking resources) at the functional, logical, and physical layers on which the application depends. A vertical topology view based on a physical resource may depict all of the resources and entities at the logical and functional layers that the physical resource supports. Once a topology view is obtained, it may be stored for future reference.

Cloud Mining Server—

The cloud mining server may facilitate a data mining sandbox that allows a user to verify or explore unknown characteristics of a cloud environment. The environment may cover all objects referenced in various logs or information managed by the cloud service brokering facility 204. The cloud mining server may support both ad hoc search interfaces and some formal SQL and non-SQL query interfaces. In addition, the cloud mining server may support an application programming interface (API) to allow users to develop custom algorithms to manipulate the data directly. The server also may support a rich set of pre-built data visualization tools and a multi-user sandbox environment that allows the users to share their work with each other.

The cloud service brokering facility 204 may include various intelligence functional modules as may serve a particular implementation. Such intelligence functional modules may include a procurement advisor, a cloud broker, and a cloud auditor. Each of these intelligence functional modules will now be described.

Procurement Advisor—

This is a decision support tool that may help a user to make cloud resource procurement decisions. A user may specify a set of cloud resource requirements in the form of a resource package. The procurement advisor may search through a set of the service catalogs selected by the user and report the result that may be sorted by cost, performance, and availability criteria.

It is understood that at times the cloud service brokering facility 204 may decide whether it is better to procure cloud resources from a cloud service provider or to use a user's in-house cloud network for an application. The procurement advisor allows a user to define in-house cloud resources and turn the information into a private cloud resource service catalog. The private service catalog may then be included in future search requests.

Cloud Broker—

The cloud broker is an agent acting on behalf of a user to automate cloud operation processes. A cloud operation process may include, for example, procuring resources, provisioning and configuring the resources, setting up the workload execution environments, transporting the workload to the destination resources, launching the workload, monitoring the execution, performing any necessary exception conditions handling process, ending the workload, returning procured resources, and completing the workload request. The user may specify all the parameters for each step of the process. Once a user approves the process, the broker may execute each step and record the progress in a log which may be viewed in real time. The parameters used to specify the process may be saved for future reuse and the progress may be logged for future analysis.

Cloud Auditor—

The cloud auditor is a tool that allows users to examine different aspects of cloud operations such as, for example, security, charging, service level agreement (SLA), and performance. One of the challenges with auditing is dealing with systems whose behaviors and environments change continuously. With many moving parts, results collected at one time may not hold true at another time. If the auditing process is to be conducted constantly, it may interfere with the normal operations of the applications. In one implementation, the cloud auditor may be configured to conduct random auditing. With the cloud auditor, a user may schedule some pre-defined scripts to run in some randomly selected time. The scope of the audit may also be randomly selected to minimize an impact on system performance.

The result of the auditing activities may be recorded in activity log for report generation and/or investigation. A user may, through, for example, the interface facility 202, specify search criteria and the cloud auditor may be configured to search through the log to extract report and/or any unusual occurrences. With other log data generated by the cloud service brokering facility 204, the user may identify these occurrences to identify the resources, locations, and/or the users involved. The audit reports may also serve as basis for meeting different business, regulatory process, and reporting requirements.

The various functions of the cloud service brokering facility 204 may be supported by sharing state information of the cloud environment. The following is an exemplary list of the information objects that the cloud service brokering facility 204 may provide through the interface facility 202 to a user. These objects may be organized under three user domains: customer, cloud service provider, and system, which are set forth in detail below.

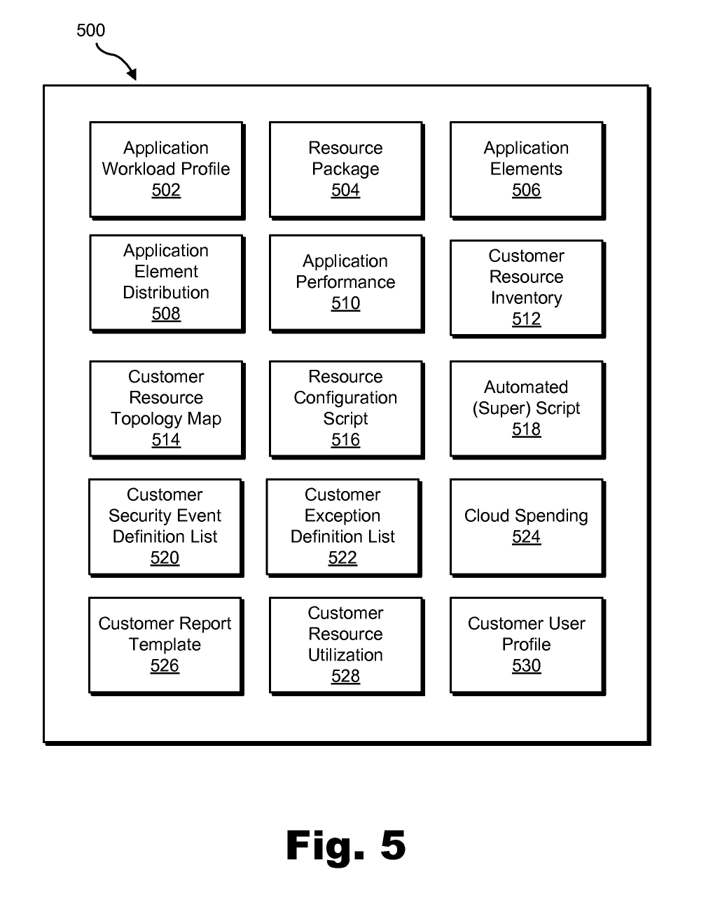

FIG. 5 illustrates exemplary informational objects that may be provided in the customer domain. As used herein, the “customer domain” refers to the informational objects that may be useful to a customer to examine and evaluate services provided through the system 102. As seen in FIG. 5, the customer domain 500 may include an application workload profile 502, a resource package 504, one or more application elements 506, an application element distribution 508, an application performance 510, a customer resource inventory 512, a customer resource topology map 514, a resource configuration script 516, an automated (super) script 518, a customer security event definition list 520, a customer exception definition list 522, a cloud spending 524, a customer report template 526, a customer resource utilization 528, and a customer user profile 530 informational object(s). These informational objects that may be provided in the customer domain 500 are described in detail below.

Application Workload Profile 502—

This object may maintain the characteristics of a cloud application when it is run on a specific resource package. It may contain two information objects: workload characteristics and resource package. The resource package information may be specified by the user to run the application. The workload characteristics information may be collected by the cloud resources while the application is running. It may include, for example, CPU usage, memory utilization, paging information, system processes/threads, storage consumption and access pattern, traffic volume and distribution patterns. This information is typically extracted from the logs generated by the operating systems, storage systems, and network routers/switches.

Resource Package 504—

This package may be used to describe the collection of different cloud resources. A resource may be marked for dedicated use or shared use. The package may be used to define a set of resource requirements or an instance of a collection of resources for an application. The resource package 504 may include various components as may serve a particular implementation. Such components may include a compute resource profile, a storage resource profile, a transport resource profile, and a network virtual server resource profile. Each of these components will now be described.

Compute Resource Profile—

This component may contain a set of requirements for compute resources. For example, the compute resource profile may specify CPU type, clock rate, and/or memory. In addition, the compute resource profile may include hypervisor, OS, and/or version numbers as part of the requirement.

Storage Resource Profile—

This component may contain a set of requirements for a storage resource. For example, the storage resource profile, may include types of storage (e.g., solid-state drive (SDD), magnetic storage, optical storage, etc.), capacity (e.g., number of bytes) and read/write performance. Furthermore the storage resource profile may specify whether the application will use any of block storage or object storage and any database systems.

Transport Resource Profile—

This component may contain a set of requirements for WAN resources. The transport resource profile may include, for example, bandwidth requirements, network reachability, locations, quality of service (QoS) profile, Layer 2/3, IP addresses, VLAN ID, etc.

Network Virtual Server Resource Profile—

This component may contain a set of requirements for edge network resources. These resources may include, for example, virtual consumer electronics (CE) router, switch, firewall, bandwidth, interfaces, domain name system (DNS), etc.

Application Elements 506—

The application elements of an application may refer to all of the processes and persistent data modules. The persistent data modules are typically stored in database systems or file servers.

Application Element Distribution 508—

This information object may maintain the mapping of application elements and the cloud resources used to support the application. The application elements may correspond to the processes and persistent data modules of an application. In a cloud environment, the application elements may reside in resources distributed across hardware platforms in different geographical locations. While the mapping of the processes and data modules to the cloud resources may be specified explicitly by the user, they may also be automatically assigned to different resources by some load distribution systems. The information may be useful for review and/or verification purposes. To generate the distribution information, the cloud service brokering facility 204 may extract relevant data from the log files to track the activities for the processes and the external data references.

Application Performance 510—

This information object provides a list of performance metrics for a specific application. The performance metrics may include, for example, process service time, waiting time, data access delays, network delays, etc. Because the performance of an application is related to both the load of the application and the resource capability, each set of performance metrics may include information about the application load and the resource set used to support the application. The information will allow the user to determine whether additional resources would be helpful due to the load conditions or whether some higher performance resources may be used to improve the end user performance experience.

Customer Resource Inventory 512—

This object may keep track of the cloud resources of a customer. This object may include public as well as private resources. While the public resource information may be gathered from resource catalogs and resource procurement logs, the customer may provide the information for the private resources. Each resource may contain information about the technical specification, location, account code, availability, quantity, etc.

Customer Resource Topology Map 514—

This object may provide different topological views of all the resources of a customer as reported in the customer's resource inventory object. The three layers of topological views may be physical, logical, and functional.

Resource Configuration Script 516—

This type of script may be used by a user to configure cloud resources for an application. The user may store it in the cloud service brokering facility 204 and retrieve it from another script.

Automated (Super) Script 518—

This type of script may allow a user to control the execution of different resource configuration scripts.

Customer Security Event Definition List 520—

This is a list of customer specific security event definitions. The event definitions may be specified by a set of conditions that may be resolved by the logs of the cloud service brokering facility 204.

Customer Exception Definition List 522—

This list defines conditions and handling methods for exception events. The exceptions are defined for customer resources procured from a cloud service provider or owned. Each event may be categorized by its severity, resource types, resource locations, resource ID, event groups, etc.

Cloud Spending 524—

This object may contain information about a cloud resource spending status of a customer. This object may be constructed from the procurement transaction log and may allow the user to view the spending information by, for example, account, date, resource types, location, provider, user, application, trend, billing cycle, running total, etc.

Customer Report Template 526—

This object may contain a list of customized templates of a set of standard analytics reports (see also System Report Template). The customizable parameters may include time, duration, frequency, resource scope, performance metric, geo-location scope, etc.

Customer Resource Utilization 528—

This object may contain the utilization information of a customer's resources. Utilization information for different types of resources may be measured by different sets of dimensions. For compute resources, this object may measure CPU time, frequency of boosting, memory usage, paging size, etc. For storage resources, this object may measure access frequency, access types, allocated storage, actual data size, etc. For transport resource, this object may measure throughput, queening length, dropped packets, etc. The information is typically extracted from the logs in the system and may be viewed by different resource types and compared by different time periods, locations, account codes, etc.

Customer User Profile 530—

This object may contain information related to the profile of the customer including, for example, location information, contact information, personal preference information, user identification, security credentials, access privileges, etc.

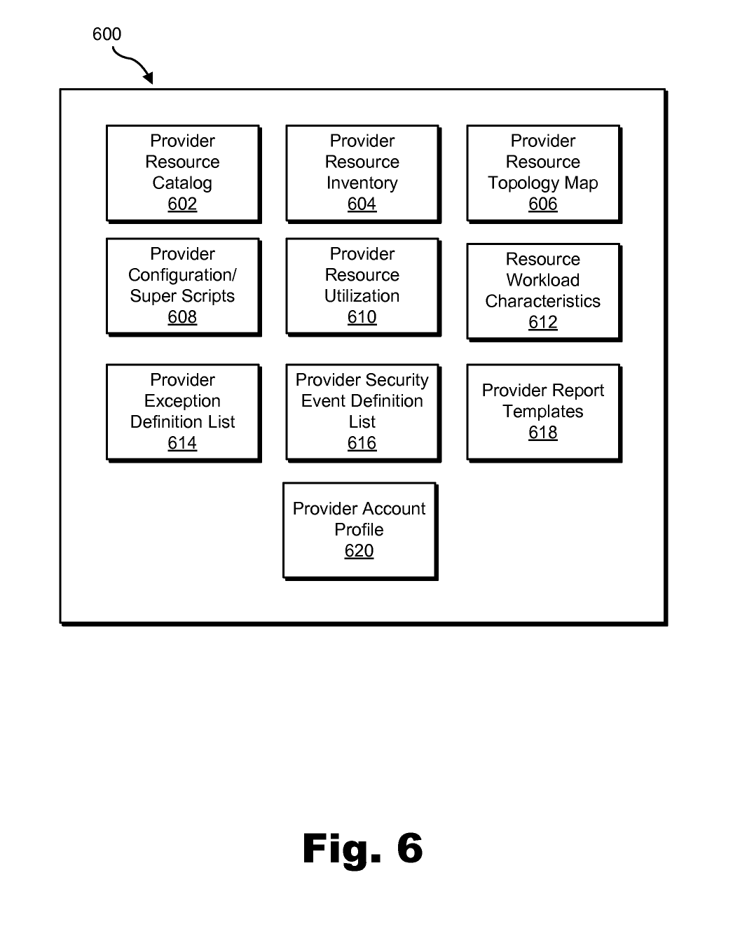

FIG. 6 illustrates exemplary informational objects that may be provided in the provider domain. As used herein, the “provider domain” refers to the informational objects that may be useful to a cloud service provider to examine and evaluate services provided through the system 102. As seen in FIG. 6, the provider domain 600 may include a provider resource catalog 602, a provider resource inventory 604, a provider resource topology map 606, one or more provider configuration/super scripts 608, a provider resource utilization 610, one or more resource workload characteristics 612, a provider exception definition list 614, a provider security event definition list 616, one or more provider report templates 618, and a provider account profile 620 informational object(s). These informational objects that may be provided in the provider domain 600 are described in detail below.

Provider Resource Catalog 602—

This object may capture a cloud service provider's catalog of its resources available to the customers. This object may also include different price options for different types of customers (or contract types). This object may be used by the cloud service brokering facility 204 to estimate the cost of leasing the cloud service provider's resource.

Provider Resource Inventory 604—

This object may capture inventory of all the cloud resources offered by a cloud service provider through one or more cloud computing systems 104. The inventory may include, for example, all the technical specification, geo-location and/or resource status information associated with a particular cloud resource 106. This object also may keep track of the availability and occupancy of the cloud resource 106.

Provider Resource Topology Map 606—

This object includes a map of the locations of all the cloud resources of the cloud service providers. The topology may be organized into physical, logical, and functional layers. The topological information presented in the map may be based primarily on the information provided by the cloud service providers and verified via the logs collected.

Provider Configuration/Super Scripts 608—

This object includes scripts that may be used by a cloud service provider to configure or reconfigure a cloud resource 106 before or after it is used by a customer of the cloud service brokering service 110.

Provider Resource Utilization 610—

This object may capture the resource utilization information of a cloud service provider's cloud resources 106. The information may be extracted from different log files generated by or for the cloud resources 106. The usage information may cover, for example, metrics for compute, storage, service, and transport resources.

Resource Workload Characteristics 612—This object may provide information on the characteristics of workload placed on the cloud resources 106. The cloud service provider may use the information as input to improve service and support SLA. The resource workload characteristics 612 may include various types of information. Such information may include transport characteristics, compute resources, storage resources, and network virtual server resources. Each of these types of information will now be described.

Transport Characteristics—

For example, traffic volume, geo-location distribution, traffic type composition, protocol types, throughput, etc.

Compute Resources—

For example, OS types, CPU utilization, process distribution, memory consumption, local inter-process traffic, inter-server traffic, paging statistics, disk access pattern, and storage patterns.

Storage Resources—

For example, access pattern (sequential, random), access objects (block based, object based), database types, etc.

Network Virtual Server Resources—

For example, a virtual firewall—ingress/egress traffic load, CPU usage, memory usage, service features (access control list (ACL), NAT, VLAN, IPSec, application layer filtering, etc), and a virtual router—interface traffic load, CPU and memory usage, service features (filtering, NAT, etc.), traffic mixture by class of service or type of service (TOS), and traffic matrix.

Provider Exception Definition List 614—

This object may define the conditions and handling methods for exception events. The exceptions may be defined for the provider's resources only. Each event may be categorized, for example, by its severity, resource types, resource locations, resource id, etc.

Provider Security Event Definition List 616—

This object may contain additional security event definitions as specified by the cloud service provider.

Provider Report Templates 618—

This object may contain customized report templates based on the standard system report templates. A cloud service provider may include additional parameters to filter the output based on, for example, time, duration, frequency, resources, and customer scopes.

Provider Account Profile 620—

This object may contain all the account information for users and systems together with access privileges and role assignment information.

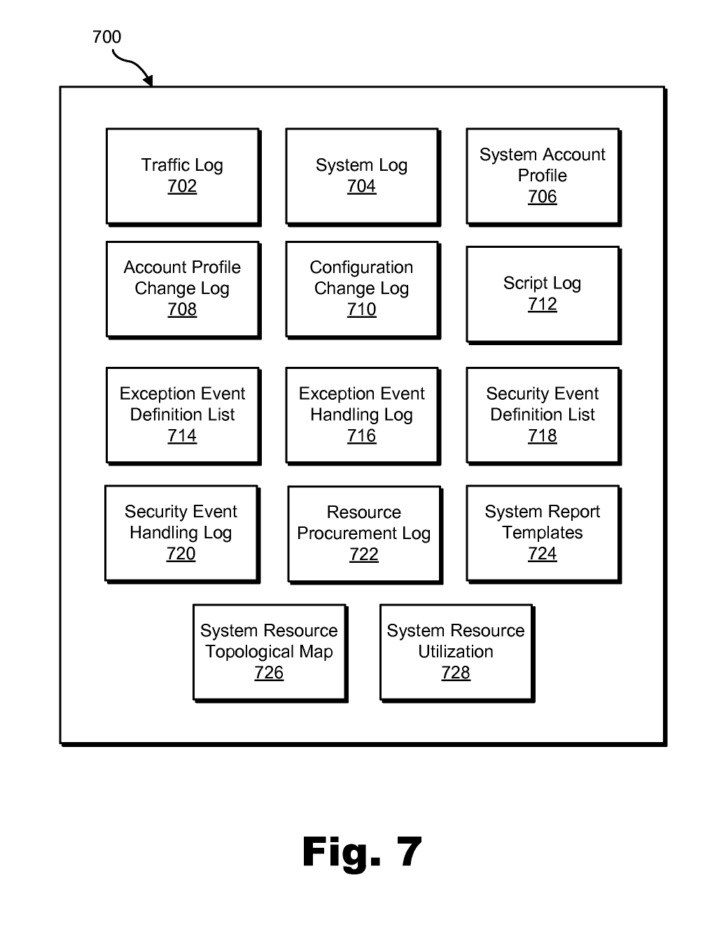

FIG. 7 illustrates exemplary informational objects that may be provided in the system domain. As used herein, the “system domain” refers to the informational objects that may be useful to the system 102 to examine and evaluate services provided as part of the cloud service brokering service 110. As seen in FIG. 7, the system domain 700 may include a traffic log 702, a systems log 704, a system account profile 706, an account profile change log 708, a configuration change log 710, a script log 712, an exception event definition list 714, an exception event handling log 716, a security event definition list 718, a security event handling log 720, a resource procurement log 722, one or more system report templates 724, a system resource topological map 726, and a system resource utilization 728 informational object(s). These informational objects that may be provided in the system domain 700 are described in detail below.

Traffic Log 702—

This information object is a generic reference to different types of traffic logs that may be reported by cloud resources 106 and/or one or more other elements of system 100. As traffic is transported from one entity (compute server/storage server) to another, the transaction may be recorded in a traffic log. The log may be used for monitoring exception conditions, measuring traffic volume, and/or calculating the performance of the transport networks, traffic matrix, etc. Common traffic logs may include Netflows, Jflows, sflow, IP Fix, etc. This may be used to verify and correlate log information from other sources. In a multi-tenant network environment, each log may be annotated with appropriate context and owner information to differentiate the scope of the data. In addition, in an environment where network address translation (NAT) is used, the binding of the NAT addresses may also be useful to correlate logs from different segments of the networks.

System Log 704—

This information object is a generic reference to logs of information processing systems such as Syslog. Each log may contain an event message encoded with information about, for example, facility, severity, timestamp, host id, and/or additional content. The specificity of the message content however may vary from system to system. Meta-information for each system may be useful to decode the content correctly before it may be processed. In some implementations, additional annotations may be added to the log to identify the scope of the data.

System Account Profile 706—

This profile may contain identification, role and responsibility, and security privileges of each user and system account. The user account may be used by the brokering system 102 to identify who the user is and if the user is allowed to perform certain actions. The content may be first created by a user with administrative privileges and later modified by the user. The system account may be used by the brokering system 102 to logon to external systems. The use of system account may be governed by the security privilege granted to each user.

Account Profile Change Log 708—

This log may be configured to record all the changes made to the account profiles. It may contain, for example, the time, user, and the changes made to the profile.

Configuration Change Log 710—

This log may be used to record the changes made to the configuration of a resource. It may also include the information about the user who made the changes and/or the timestamp.

Script Log 712—

This log may record all the activities of running scripts through the cloud service brokering facility 204.

Exception Event Definition List 714—

This object may include a list of exception event definitions and handling actions. An exception event definition may specify the conditions under which an exception event is triggered. Each exception event may further be defined with severity level. The handling actions may be a list of actions to be performed by the cloud service brokering facility 204 once the exception event is reported. A handling action may be as simple as, for example, sending a text message to a mobile device or running a script to re-start a process.

Exception Event Handling Log 716—

This log may record all the exception events reported by different systems. It may contain information about, for example, event types, severity levels, timestamps, system id, etc. It may record the handling actions taken and any response received for each exception handling event.

Security Event Definition List 718—

This object may include a list of a basic security event as defined by the system administrator. Each customer or cloud service provider may enhance this list by adding more definitions to meet their specific requirements. The security events may be group under: account status change events, external traffic exchange events, local traffic exchange events, and data object access events.

Security Event Handling Log 720—

This log may record the occurrence and handling of the events defined in the security event definition list. This log may provide the data useful for correlating events from different sources, for information needed to comply with security and governing requirements, and/or for future analysis or forensic investigations.

Resource Procurement Log 722—

This log may record the transaction of procuring cloud resources. It may include, for example, the time, personnel, the resources procured, the cost or cost rate, the resource, the user id, the provider id, account information, etc. One or more transactions may be generated when the cloud resources are released back to the cloud service provider or when the cloud resources have been used beyond a billing period. The cloud service brokering facility 204 may be configured to use this log to compute the running total cloud spending or earning for any time period.

System Report Templates 724—

This object may include a set of standard analytics report templates supported by the cloud service brokering facility 204. The templates may be grouped under the following categories: resource Inventory/occupancy; resource usage; resource performance; resource workload characteristics; application performance; application workload characteristics; resource/application traffic statistics; exception occurrence; exception event listing; security event report; security event listing; script listing; resource procurement; resource spending/earning; user profile; system usage; system performance; system exception events; log inventory; and log extract. Each report template may support a number of customization parameters. Some customization parameters may be, for example, time, duration, geo-location, resource scope, user's scope and privilege level, etc.

System Resource Topological Map 726—

This object may include a map of all cloud resources available for procurement through the cloud service brokering facility 204. It may be filtered by provider, location, resource type, etc. The information may be extracted from combining cloud service providers' service catalogs.

System Resource Utilization 728—

This object may include the resource utilization of the cloud service brokering facility 204 itself. This object may record usage information such as, for example, user number, session number, session duration, session activities, start and end time, storage usage, system interface bandwidth usage, etc.

The cloud service brokering facility 204 may interact with various different external entities via different interfaces that form part of the interface facility 202. The following describes the different interfaces that the cloud service brokering facility 204 may use in providing the cloud service brokering service 110.

Operator User Interfaces—

This set of interfaces may be implemented through the interface facility 202 and may be used to support operations, administration, maintenance and provisioning (OAM and P) services of the cloud service brokering facility 204. This set of interfaces may support both GUI and command-line interfaces, and may be useful to support provisioning and configuration. The following is the list of exemplary services that may be supported by the interfaces: report manager; security manager; exception manager; log manager; configuration manager; system account profile manager; system configuration; system account configuration; system log management; system report management; system CUP management; system exception management; and system security management services.

External Service Interfaces—

This set of interfaces may be implemented through the interface facility 202 and may be used to connect to external systems to access services to support the functions of the cloud service brokering facility 204. Examples of these services may include: domain name services; mail exchange services; network time services; security certificate services; user authentication services (e.g., SSO); and archiving services

Provider System Interfaces—

This set of interfaces may be implemented through the interface facility 202 and may be used by cloud service providers to access system services. It may support both GUI and command-line interfaces. In certain examples, the cloud service providers may be able to use the interfaces to access the following functional modules: workload analyzer; cloud mining server; topology analyzer; spending/earning analyzer; resource analyzer; log analyzer; report manager; cost manager; security manager; CUP manager; exception manager; log manager; configuration manager; and system account profile manager.

Provider Business Services Interfaces—

This set of interfaces may be implemented through the interface facility 202 and may be used by the cloud service brokering facility 204 to assess a cloud service provider's business systems. In certain examples, These interfaces may be used to perform the following set of functions: to request resource quote dynamically; to download resource catalogs from provider; to update billing information to the provider; to report exception or security events to provider; to upload reports to provider; to upload log files to provider; to conduct source procurement transactions with provider; to negotiate resource service parameters with provider; and to interface with provider security database systems.

Customer System Interfaces—

This set of interfaces may be implemented through the interface facility 202 and may be used by customer users to access system functions. It may support both GUI and Command-line interfaces. The list of functional modules that may be accessed via customer system interfaces may include: procurement advisor; cloud broker; cloud auditor; cloud mining server; workload analyzer; topology analyzer; spending/earning analyzer; resource analyzer; log analyzer; report manager; cost manager; security manager; CUP manager; exception manager; log manager; configuration manager; compute resource procurement manager; network resource procurement manager; and system account profile manager modules.

Customer Business Services Interfaces—

This set of interfaces may be implemented through the interface facility 202 and may be used by the cloud service brokering facility 204 to assess a customer's business systems. In certain examples, these interfaces may be used: to conduct resource procurement transactions for customer; to negotiate resource service parameters; to report exception/security events; to report billing records; to interface with customer security database systems; to upload reports to customer; to upload log files to customer; and to download resource image, and/or configuration files from the customer.

Provider Cloud Resource Interfaces—

These interfaces may be implemented through the interface facility 202 and may be used by the cloud service brokering facility 204 to communicate with cloud service providers' resources 106. The cloud resources 106 may support different interfaces such as GUI, command-line interface (CLI), console and remote management interfaces. In certain examples, the interfaces may allow the cloud service brokering facility 204 to perform the following functions: to provision and configure the resource; to collect resource status information; to receive resource exception notification messages; to download resource system files; to upload/download image files; to run diagnostics routines on resource; to redirect CLI sessions to system sessions; to download log files; to monitor resource health conditions; and to connect to third party resources.

Customer Cloud Resource Interfaces—

These interfaces may be implemented through the interface facility 202 and may be used by the cloud service brokering facility 204 to communicate with the customer's resources. It will be understood that the customers may have access to both private and public cloud resources. Depending on the type of cloud services procured, the cloud service brokering facility 204 may access only a subset of functions supported by the resources. Otherwise the cloud service brokering facility 204 may access the same list of functions listed under the provider cloud resource interfaces.

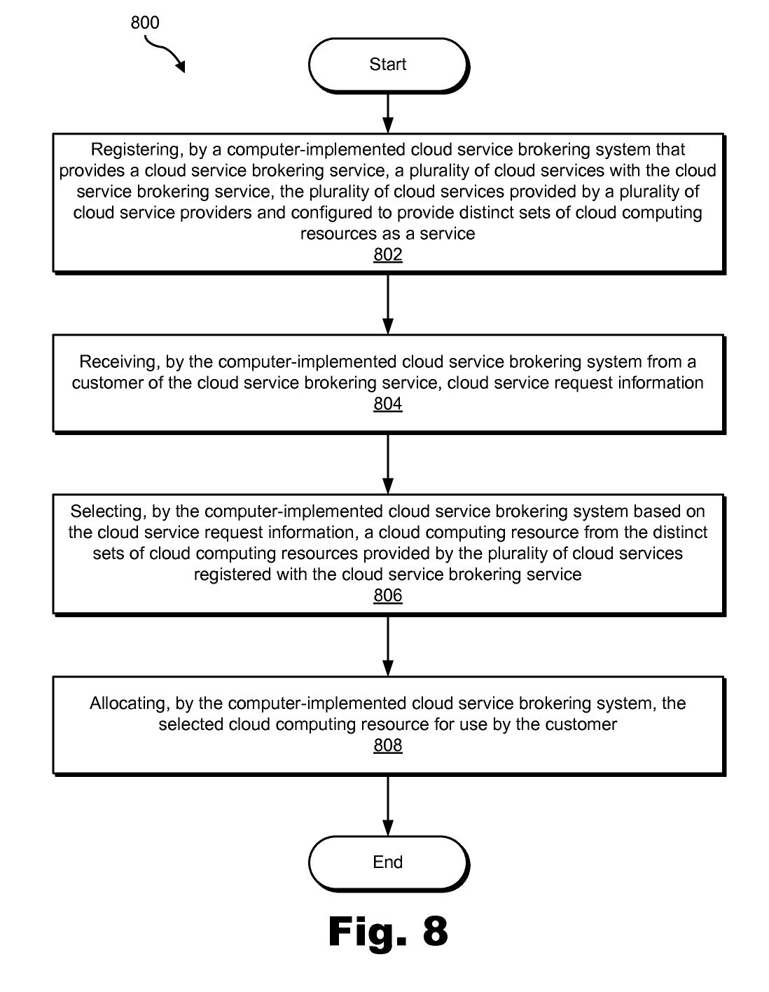

FIG. 8 illustrates an exemplary cloud service brokering method 800. While FIG. 8 illustrates exemplary steps according to one embodiment, other embodiments may omit, add to, reorder, combine, and/or modify any of the steps shown in FIG. 8. In certain embodiments, one or more of the steps shown in FIG. 8 may be performed by one or more components of the brokering system 102.

In step 802, a plurality of cloud services 108 may be registered with a cloud service brokering service. The plurality of cloud services 108 may be provided by a plurality of cloud service providers and may be configured to provide distinct sets of cloud resources 106 as a service, such as described herein.

In step 804, the brokering system 102 may receive cloud service request information from the customer of the cloud service brokering service, such as described herein.

In step 806, the brokering system 102 may select, based on the cloud service request information, a cloud computing resource 106 from the distinct sets of cloud computing resources provided by the plurality of cloud services 108 registered with the cloud service brokering service, such as described herein.

In step 808, the brokering system 102 may allocate the selected cloud computing resource 106 for use by the customer. For example, the brokering system 102 may enable the selected cloud computing resource 106 to be accessible by the customer via the customer computing system 112, such as described herein.

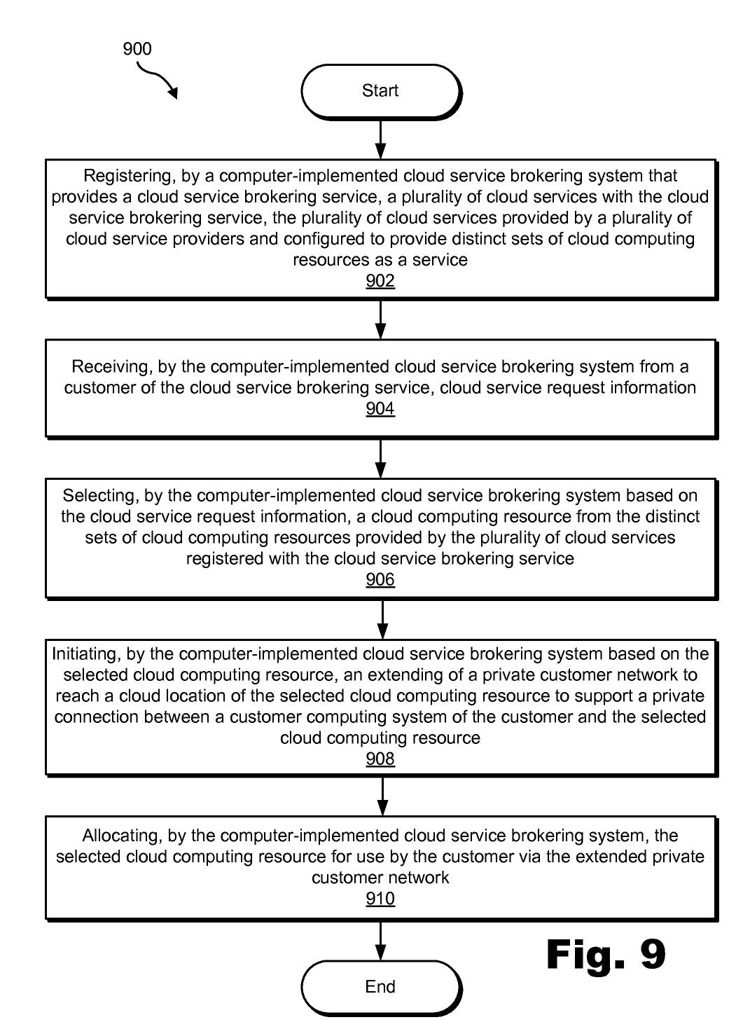

FIG. 9 illustrates an exemplary cloud service brokering method 900. While FIG. 9 illustrates exemplary steps according to one embodiment, other embodiments may omit, add to, reorder, combine, and/or modify any of the steps shown in FIG. 9. In certain embodiments, one or more of the steps shown in FIG. 9 may be performed by one or more components of brokering system 102.

In step 902, a plurality of cloud services 108 may be registered with a cloud service brokering service. The plurality of cloud services 108 may be provided by a plurality of cloud service providers and may be configured to provide distinct sets of cloud resources 106 as a service, such as described herein.

In step 904, the brokering system 102 may receive cloud service request information from the customer of the cloud service brokering service, such as described herein.

In step 906, the brokering system 102 may select, based on the cloud service request information, a cloud computing resource 106 from the distinct sets of cloud computing resources provided by the plurality of cloud services 108 registered with the cloud service brokering service, such as described herein.

In step 908, the brokering system 102 may initiate, based on the selected cloud computing resource 106, an extending of a private customer network to reach a cloud location of the selected cloud computing resource 106 to support a private connection between a customer computing system 112 of the customer and the selected cloud computing resource 106, such as described herein.

In step 910, the brokering system 102 may allocate the selected cloud computing resource 106 for use by the customer via the extended private customer network. For example, the brokering system 102 may enable the selected cloud computing resource 106 to be accessible by the customer via the customer computing system 112 by way of the extended private customer network, such as described herein.

In certain embodiments, one or more of the components and/or processes described herein may be implemented and/or performed by one or more appropriately configured computing devices. To this end, one or more of the systems and/or components described above may include or be implemented as one or more computing systems and/or components by any computer hardware, computer-implemented instructions (e.g., software) embodied in a non-transitory computer-readable medium, or combinations of computer-implemented instructions and hardware, configured to execute one or more of the processes described herein. In particular, system components may be implemented on one physical computing device or may be implemented on more than one physical computing device. Accordingly, system components may include any number of physical computing devices, and may employ any of a number of computer operating systems.

In certain embodiments, one or more of the processes described herein may be implemented at least in part as instructions embodied in a non-transitory computer-readable medium and executable by one or more computing devices. In general, a processor (e.g., a microprocessor) receives instructions, from a non-transitory computer-readable medium, (e.g., a memory, etc.), and executes those instructions, thereby performing one or more processes, including one or more of the processes described herein. Such instructions may be stored and/or transmitted using any of a variety of known computer-readable media.

A computer-readable medium (also referred to as a processor-readable medium) includes any non-transitory medium that participates in providing data (e.g., instructions) that may be read by a computer (e.g., by a processor of a computer). Such a medium may take many forms, including, but not limited to, non-volatile media and/or volatile media. Non-volatile media may include, for example, optical or magnetic disks and other persistent memory. Volatile media may include, for example, dynamic random access memory (DRAM), which typically constitutes a main memory. Common forms of computer-readable media include, for example, a floppy disk, flexible disk, hard disk, magnetic tape, any other magnetic medium, a Compact Disc Read-Only Memory (CD-ROM), DVD, any other optical medium, a Random-Access Memory (RAM), a Programmable ROM (PROM), an Erasable PROM (EPROM), a Flash Electrically EPROM (FLASH-EEPROM), any other memory chip or cartridge, or any other tangible medium from which a computer may read.

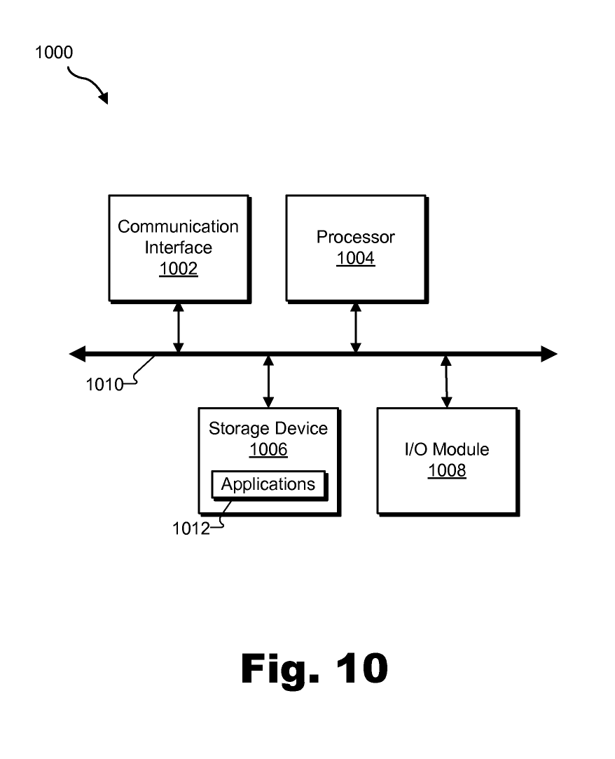

FIG. 10 illustrates an exemplary computing device 1000 that may be configured to perform one or more of the processes described herein. As shown in FIG. 10, computing device 1000 may include a communication interface 1002, a processor 1004, a storage device 1006, and an input/output (I/O) module 1008 communicatively connected via a communication infrastructure 1010. While an exemplary computing device 1000 is shown in FIG. 10, the components illustrated in FIG. 10 are not intended to be limiting. Additional or alternative components may be used in other embodiments. Components of computing device 1000 shown in FIG. 10 will now be described in additional detail.

Communication interface 1002 may be configured to communicate with one or more computing devices. Examples of communication interface 1002 include, without limitation, a wired network interface (such as a network interface card), a wireless network interface (such as a wireless network interface card), a modem, and any other suitable interface. In at least one embodiment, communication interface 1002 may provide a direct connection between configuration 100 and one or more of provisioning systems via a direct link to a network, such as the Internet. Communication interface 1002 may additionally or alternatively provide such a connection through, for example, a local area network (such as an Ethernet network), a personal area network, a telephone or cable network, a satellite data connection, a dedicated URL, or any other suitable connection. Communication interface 1002 may be configured to interface with any suitable communication media, protocols, and formats, including any of those mentioned above.

Processor 1004 generally represents any type or form of processing unit capable of processing data or interpreting, executing, and/or directing execution of one or more of the instructions, processes, and/or operations described herein. Processor 1004 may direct execution of operations in accordance with one or more applications 1012 or other computer-executable instructions such as may be stored in storage device 1006 or another computer-readable medium.

Storage device 1006 may include one or more data storage media, devices, or configurations and may employ any type, form, and combination of data storage media and/or device. For example, storage device 1006 may include, but is not limited to, a hard drive, network drive, flash drive, magnetic disc, optical disc, random access memory (RAM), dynamic RAM (DRAM), other non-volatile and/or volatile data storage units, or a combination or sub-combination thereof. Electronic data, including data described herein, may be temporarily and/or permanently stored in storage device 1006. For example, data representative of one or more executable applications 1012 (which may include, but are not limited to, one or more of the software applications described herein) configured to direct processor 1004 to perform any of the operations described herein may be stored within storage device 1006. In some examples, data may be arranged in one or more databases residing within storage device 1006.

I/O module 1008 may be configured to receive user input and provide user output and may include any hardware, firmware, software, or combination thereof supportive of input and output capabilities. For example, I/O module 1008 may include hardware and/or software for capturing user input, including, but not limited to, a keyboard or keypad, a touch screen component (e.g., touch screen display), a receiver (e.g., an RF or infrared receiver), and/or one or more input buttons.

I/O module 1008 may include one or more devices for presenting output to a user, including, but not limited to, a graphics engine, a display (e.g., a display screen, one or more output drivers (e.g., display drivers), one or more audio speakers, and one or more audio drivers. In certain embodiments, I/O module 1008 is configured to provide graphical data to a display for presentation to a user. The graphical data may be representative of one or more graphical user interfaces and/or any other graphical content as may serve a particular implementation.

In some examples, any of the subsystems described herein may be implemented by or within one or more components of computing device 1000. For example, one or more applications 1012 residing within storage device 1006 may be configured to direct processor 1004 to perform one or more processes or functions associated with the cloud service brokering system 102, or any components thereof.

To the extent the aforementioned embodiments collect, store, and/or employ personal information provided by individuals (or other entities), it should be understood that such information shall be used in accordance with all applicable laws concerning protection of personal information. Additionally, the collection, storage, and use of such information may be subject to consent of the individual to such activity, for example, through well known “opt-in” or “opt-out” processes as may be appropriate for the situation and type of information. Storage and use of personal information may be in an appropriately secure manner reflective of the type of information, for example, through various encryption and anonymization techniques for particularly sensitive information.

In the preceding description, various exemplary implementations have been described with reference to the accompanying drawings. It will, however, be evident that various modifications and changes may be made thereto, and additional implementations may be provided, without departing from the scope of the invention as set forth in the claims that follow. For example, certain features of one implementation described herein may be combined with or substituted for features of another implementation described herein. The description and drawings are accordingly to be regarded in an illustrative rather than a restrictive sense.

What is claimed is:

1. A method comprising:
registering, by a computer-implemented cloud service brokering system that provides a cloud service brokering service, a plurality of cloud services with the cloud service brokering service, the plurality of cloud services provided by a plurality of cloud service providers and configured to provide distinct sets of cloud computing resources as a service;
receiving, by the computer-implemented cloud service brokering system from a customer of the cloud service brokering service, cloud service request information;
selecting, by the computer-implemented cloud service brokering system based on the cloud service request information, a cloud computing resource from the distinct sets of cloud computing resources provided by the plurality of cloud services registered with the cloud service brokering service; and
allocating, by the computer-implemented cloud service brokering system, the selected cloud computing resource for use by the customer.

2. The method of claim 1, further comprising:
modifying, by the computer-implemented cloud service brokering system, a customer network to accommodate the allocating of the selected cloud computing resource for use by the customer.

3. The method of claim 2, wherein the modifying of the customer network comprises extending the customer network to support a connection between a customer computing system of the customer and the selected cloud computing resource.

4. The method of claim 3, wherein the customer network is a private network.

5. The method of claim 1, wherein the selecting of the cloud computing resource is further based on cloud network capability information that specifies at least one of cloud processing capabilities of the plurality of cloud service providers, transportation characteristics of the plurality of cloud service providers, and data storage capabilities available from the plurality of cloud service providers.

6. The method of claim 1, wherein:
the cloud service request information specifies a class of traffic to be used for data transfer; and
the selecting of the cloud computing resource is based at least in part on the class of traffic.

7. The method of claim 1, wherein the cloud service request information specifies requirements for cloud processing capabilities and network transportation characteristics.

8. The method of claim 1, further comprising providing a history of the allocated cloud computing resource to at least one of the customer of the cloud service brokering service and one or more cloud service providers included in the plurality of cloud service providers.

9. The method of claim 8, wherein the history includes information regarding at least one of a category of the cloud computing resource, a cost of the cloud computing resource, the cloud service provider that provided the cloud computing resource, a customer that received the cloud computing resource, a location of the cloud computing resource, cloud computing resource utilization statistics, accounting information, and an application type of the cloud computing resource.

10. The method of claim 1, embodied as computer-executable instructions on at least one non-transitory computer-readable medium.

11. A method comprising:
registering, by a computer-implemented cloud service brokering system that provides a cloud service brokering service, a plurality of cloud services with the cloud service brokering service, the plurality of cloud services provided by a plurality of cloud service providers and configured to provide distinct sets of cloud computing resources as a service;
receiving, by the computer-implemented cloud service brokering system from a customer of the cloud service brokering service, cloud service request information;
selecting, by the computer-implemented cloud service brokering system based on the cloud service request information, a cloud computing resource from the distinct sets of cloud computing resources provided by the plurality of cloud services registered with the cloud service brokering service;
initiating, by the computer-implemented cloud service brokering system based on the selected cloud computing resource, an extending of a private customer network to reach a cloud location of the selected cloud computing resource to support a private connection between a customer computing system of the customer and the selected cloud computing resource; and
allocating, by the computer-implemented cloud service brokering system, the selected cloud computing resource for use by the customer via the extended private customer network.

12. The method of claim 11, wherein the selecting of the cloud computing resource is further based on cloud network capability information that specifies at least one of cloud processing capabilities of the plurality of cloud service providers, transportation characteristics of the plurality of cloud service providers, and data storage capabilities available from the plurality of cloud service providers.

13. The method of claim 11, wherein:
the cloud service request information specifies a class of traffic to be used for data transfer; and
the selecting of the cloud computing resource is based at least in part on the class of traffic.

14. The method of claim 11, wherein the cloud service request information specifies requirements for cloud processing capabilities and cloud transportation characteristics.

15. The method of claim 11, wherein the cloud location comprises a geo-location of the selected cloud computing resource.

16. The method of claim 11, embodied as computer-executable instructions on at least one non-transitory computer-readable medium.

17. A system comprising:
an interface facility configured to
receive and use registration information to register a plurality of cloud services provided by a plurality of cloud service providers with a cloud service brokering service, the plurality of cloud services configured to provide distinct sets of cloud computing resources as a service, and
receive cloud service request information from a customer of the cloud service brokering service; and
a computer-implemented cloud service brokering facility communicatively coupled to the interface facility and configured to broker the plurality of cloud services registered with the cloud service brokering service; and
wherein the computer-implemented cloud service brokering facility
selects, based on the cloud service request information, a cloud computing resource from the distinct sets of cloud computing resources provided by the plurality of cloud services registered with the cloud service brokering service, and
allocates the selected cloud computing resource for use by the customer.

18. The system of claim 17, wherein:
the computer-implemented cloud service brokering facility modifies a customer network to accommodate the allocating of the selected cloud computing resource for use by the customer.

19. The system of claim 18, wherein the computer-implemented cloud service brokering facility modifies the customer network by extending the customer network to support a connection between a customer computing system of the customer and the selected cloud computing resource.

20. The system of claim 19, wherein the customer network is a private network.
